(19) United States
(12) Patent Application Publication
(10) Pub. No.: US 2026/0185431 A1
(43) Pub. Date: Jul. 2, 2026

(54) E-METHANOL SAGD PLANT SYSTEM APPLICABLE TO UNCONVENTIONAL OIL PRODUCTION AREAS

(71) Applicant: Koms Co. Ltd., Busan (KR)

(72) Inventors: Hyun Kook KIM, Busan (KR); Sang Ho CHA, Busan (KR); Hyeon Seong CHOI, Busan (KR)

(73) Assignee: Koms Co. Ltd., Busan (KR)

(21) Appl. No.: 19/433,264

(22) Filed: Dec. 26, 2025

(30) Foreign Application Priority Data
Dec. 27, 2024 (KR) 10-2024-0197887

(51) Int. Cl. E21B 43/24; B01D 3/14; B01D 15/08; B01D 53/02; B01D 53/14; B01J 8/02; B01J 8/18; C25B 15/08; E21B 43/34

(52) U.S. Cl. CPC E21B 43/2406; B01D 3/143; B01D 15/08; B01J 8/0278; B01J 8/1827; C25B 15/081; E21B 43/34; B01D 53/02; B01D 53/1475; B01D 2257/504; B01D 2258/0283

(57) ABSTRACT

Disclosed is an e-methanol SAGD plant system applicable to unconventional oil production areas capable of producing e-methanol using CO₂ and carbon-reduced green hydrogen generated by a plant configured to recover bitumen using only a mixture of eco-friendly hydrogen generated by a water electrolysis apparatus and natural gas and steam instead of expanding solvent SAGD (ES-SAGD), which is a recovery method using steam, natural gas, and an additive (a solvent) used to reduce the steam-to-oil ratio (SOR), which impacts environmental pollution, when recovering an oil component from subterranean oil sands based on the widely adopted steam-assisted gravity drainage (SAGD) technology, among methods of recovering bitumen from oil sands.

### STATEMENT REGARDING GOVERNMENT SPONSORED RESEARCH

This invention was supported by the Korea Agency for Infrastructure Technology Advancement (KAIA) and the Ministry of Land, Infrastructure and Transport. [Research Project name: “R&D Program for Key Technologies in Construction of Unconventional Oil Production Plants”; Research Subject name: “Technology Development of Modular Design and Integrated Demonstration for Oil Production Plants”; Project Serial Number: 1615012996; Research Subject Number: 00143644]

### CROSS-REFERENCE TO RELATED APPLICATIONS

The present application claims priority to KR 10-2024-0197887 filed Dec. 27, 2024 in the Korean Intellectual Property Office, the disclosure of which is incorporated herein by reference in its entirety.

### BACKGROUND OF THE INVENTION

### Field of the Invention

The present invention relates to a SAGD plant system, and more particularly to an e-methanol SAGD plant system applicable to unconventional oil production areas capable of producing e-methanol using CO₂ and carbon-reduced green hydrogen generated by a plant configured to recover bitumen using only a mixture of eco-friendly hydrogen generated by a water electrolysis apparatus and natural gas and steam instead of expanding solvent SAGD (ES-SAGD), which is a recovery method using steam, natural gas, and an additive, such as a solvent, used to reduce the steam-to-oil ratio (SOR), which impacts environmental pollution, when recovering an oil component from subterranean oil sands based on the widely adopted steam-assisted gravity drainage (SAGD) technology, among methods of recovering bitumen from oil sands.

### Description of the Related Art

The recent rise in oil prices and the Ukraine war have reignited the need for oil, bringing renewed attention to unconventional oil produced by oil sand plants operating in extreme environmental conditions.

Specifically, various methods are being employed to recover bitumen, which is a type of petroleum product composed of a natural hydrocarbon compound, appearing as a black semi-solid or liquid substance soluble in carbon dioxide or liquid hydrocarbon at room temperature, and a residue generated during petroleum distillation, from subterranean deposits. Given the persistent environmental pollution issues associated with oil production, such as greenhouse gas emissions, the long-term environmental pollution reduction measure is essential. This is also a critical factor determining the sustainability of oil sand projects.

A steam-assisted gravity drainage (SAGD) method, which currently accounts for over 80% of bitumen production, uses large quantities of water, steam, and gas, major contributors to environmental pollution and greenhouse gas emissions. In order to reduce the usage of water, steam, and gas, an expanding solvent SAGD (ES-SAGD) method of mixing high-grade refined oil, such as a solvent, therewith to reduce steam usage has been used.

That is, not only are harmful substances such as H₂S generated during steam production and bitumen processing, but the process also requires vast amounts of water for steam generation. Currently, most operations rely on arbitrary wells or ponds, necessitating over three times the volume of water relative to oil produced. Even after water treatment, a part of the pollution cannot be avoided.

As the SAGD method, which uses a large amount of water, is a major cause of environmental pollution, expanding solvent SAGD (ES-SAGD) is employed to reduce steam volume by mixing high-grade refined oil such as a solvent.

In employing SAGD or ES-SAGD technology to recover bitumen from subterranean oil sands, methods capable of significantly reducing greenhouse gas emissions compared to injecting a mixture of hydrogen and natural gas, and additives, such as a solvent and CO₂, while also improving the quality of bitumen through hydrogenation reactions with the injected hydrogen are required. In this regard, in Korean Registered Patent No. 10-2840992 (registered on July 28, 2025), the applicant proposed a carbon-reduction SAGD plant system utilizing green hydrogen capable of recovering bitumen while substantially reducing greenhouse gas, conventionally the most significant issue, using only a mixture of environmentally friendly hydrogen generated by a water electrolysis apparatus and natural gas and steam.

However, transporting green hydrogen produced in unconventional oil production areas requires liquefaction, high-pressure processing, or pipeline installation, which entails high costs and hydrogen embrittlement issues.

Furthermore, due to the nature of oil sand areas requiring continuous use of natural gas as blanket gas, various gases including CO₂ generated from bitumen must be burnt by a flare stack.

### SUMMARY OF THE INVENTION

The present invention has been made in view of the above problems, and it is an object of the present invention to provide an e-methanol SAGD plant system applicable to unconventional oil production areas capable of producing e-methanol by capturing CO₂ emitted from a flare stack and mixing the same with green hydrogen generated by a carbon-reduction SAGD plant utilizing green hydrogen.

In accordance with the present invention, the above and other objects can be accomplished by the provision of an e-methanol SAGD plant system applicable to unconventional oil production areas that recover bitumen from an oil sand deposit, the e-methanol SAGD plant system including a first water treatment module configured to remove impurities from feed water in order to generate purified water, a boiler module configured to heat the purified water in order to produce steam, a hydrogen generation module configured to decompose the purified water using electricity in order to generate hydrogen, an injection well configured to supply the steam into an oil sand deposit, a hydrogen supply unit configured to supply a part of the hydrogen generated by the hydrogen generation module into the oil sand deposit, a producer well configured to recover bitumen and gas from a lower part of the oil sand deposit, a gas capture unit configured to receive natural gas from an external source and to capture CO₂ resulting from excess gas combustion, and a methanol production unit configured to produce e-methanol using the hydrogen generated by the hydrogen generation module and the CO₂ captured by the gas capture unit.

The boiler module may be configured to use the natural gas supplied from the external source and a part of the hydrogen generated by the hydrogen generation module as fuel, and the e-methanol SAGD plant system may further include a second separator configured to generate reformed hydrogen using a gas component that has passed through a first separator.

The e-methanol SAGD plant system may further include a first gas mixing module connected to the hydrogen supply unit, the first gas mixing module being configured to mix natural gas and hydrogen with each other at a set ratio and to supply the mixture into the oil sand deposit, and a second gas mixing module configured to mix the natural gas separated by the second separator and a part of the hydrogen generated by the hydrogen generation module with each other at a set ratio and to supply the mixture to the boiler module as fuel therefor.

The methanol production unit may be constituted by a Fischer-Tropsch (FT) reactor configured to reduce CO₂ on the surface of a catalyst in order to form CO, to react CO and hydrogen with each other at an active site of the catalyst in order to form hydrocarbon and an oxygen compound, and to generate methanol through C-C bond formation.

The methanol production unit may separate and purify methanol from a product generated by the FT reactor through distillation and adsorption processes.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a conceptual diagram of conventional ES-SAGD production;

FIG. 2 is a system diagram of the conventional ES-SAGD production; and

FIGS. 3 and 4 are system diagrams of an e-methanol SAGD plant according to the present invention.

### DETAILED DESCRIPTION OF THE INVENTION

Hereinafter, an e-methanol SAGD plant system applicable to unconventional oil production areas according to the present invention will be described in detail with reference to the accompanying drawings.

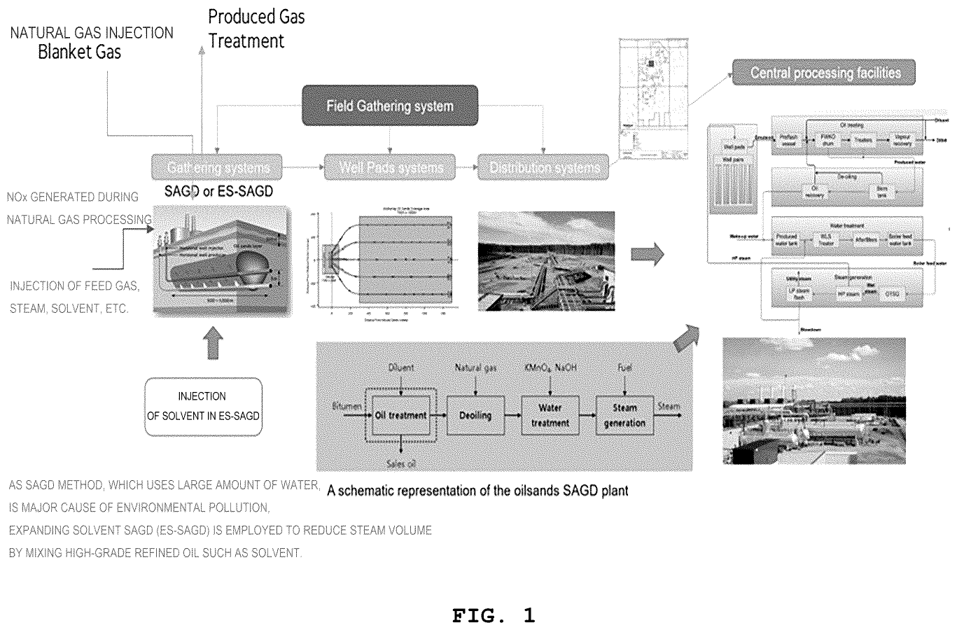

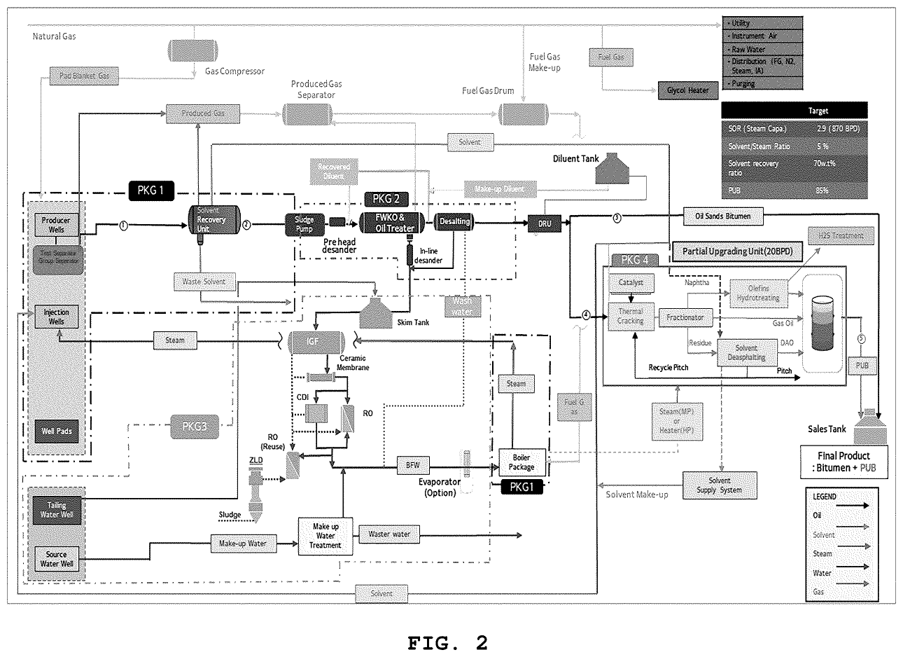

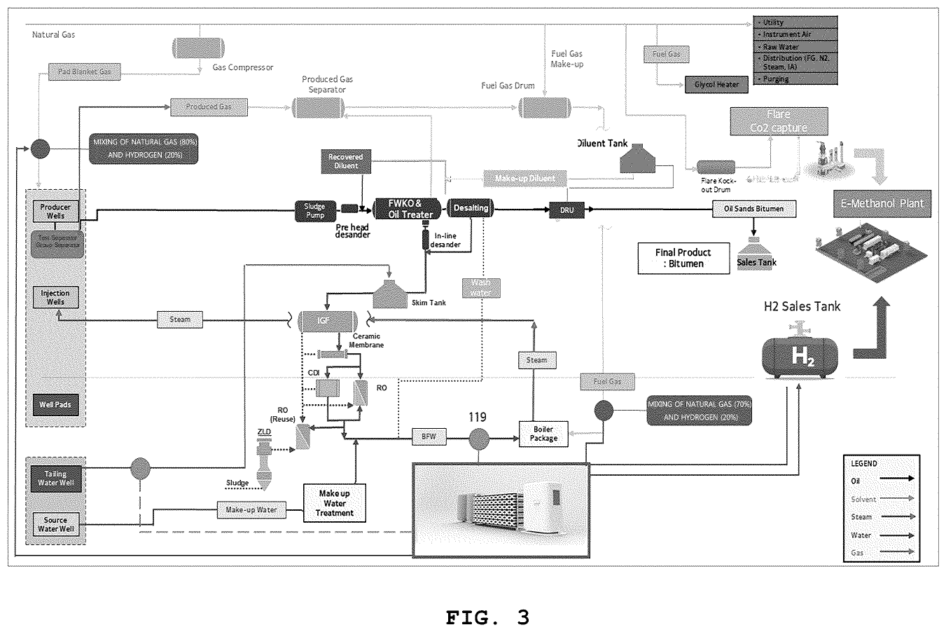

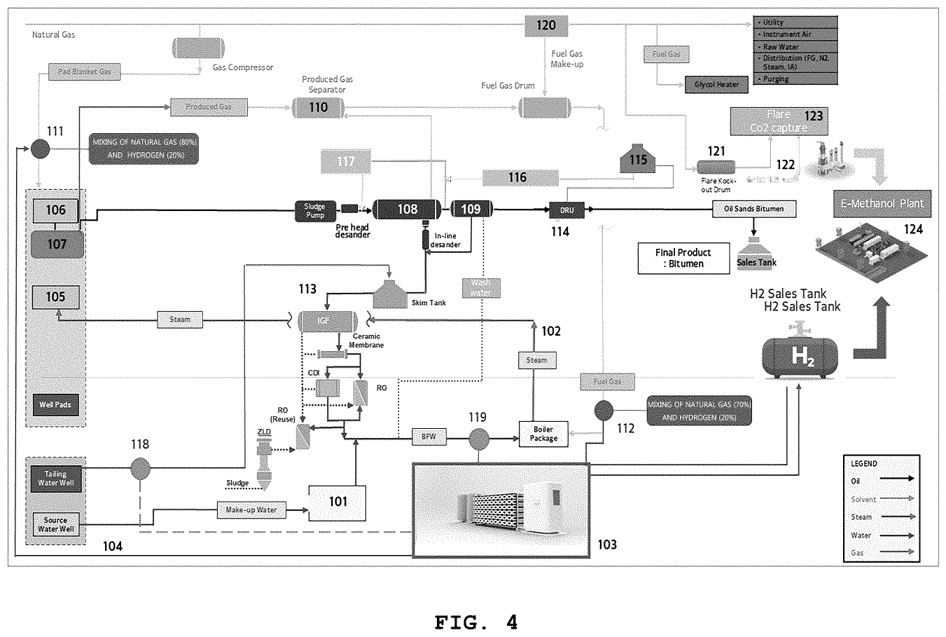

FIG. 1 is a conceptual diagram of conventional ES-SAGD production, and FIG. 2 is a system diagram of the conventional ES-SAGD production. A SAGD method requires a complex series of processes to extract bitumen solidified in oil sands and use the same as crude oil. These processes consume large quantities of water, electricity, and gas, and environmental pollution occurs in the processes due to steam and gas.

Particularly, the factors most significantly impacting greenhouse gases are steam and methane from natural gas. Lower values for the steam-to-oil ratio (SOR) and the gas-to-oil ratio (GOR) are advantageous in terms of both environmental pollution and economic viability. In order to reduce SOR and GOR, an in-situ (underground recovery) approach has been recently employed an ES-SAGD method of mixing solvent with steam to reduce natural gas volume while enhancing bitumen extraction productivity.

An ES-SAGD plant is nearly identical to a SAGD plant. The ES-SAGD plant includes an injection well for injecting gas, steam, and solvent for underground recovery, a production well for recovering bitumen underground, a well pad apparatus, which is a basic separation and processing apparatus, an oil-water separator of a central processing facility (CPF), a water treatment apparatus, and a boiler package for steam generation. An apparatus for solvent injection and recovery is added, and a partial reforming process is performed as needed.

Furthermore, water, which is a source for steam production, is obtained from both natural source water and tailing water after oil sand processing, and is treated as boiler fresh water (BFW) for supply. That is, since continuous water generation is required for BFW steam supply, sufficient water electrolysis-based water for hydrogen production, which is the characteristic of the present invention, may be readily secured.

The present invention fundamentally employs a method of recovering bitumen by mixing hydrogen generated by a water electrolysis apparatus with natural gas to reduce greenhouse gas emissions, which is identified as the most significant issue in a method of recovering bitumen from oil sands, and methanol is produced using CO₂ and hydrogen generated based thereon. That is, methanol produced in an environmentally friendly manner by reducing carbon dioxide (CO₂) emissions or using renewable resources is commonly referred to as e-methanol.

Instead of expanding solvent SAGD (ES-SAGD), which is a recovery method using steam, natural gas, and an additive, such as a solvent, used to reduce the steam-to-oil ratio (SOR), which impacts environmental pollution, when recovering an oil component from subterranean oil sands based on the widely adopted steam-assisted gravity drainage (SAGD) technology, among various methods of producing bitumen, bitumen is recovered using only a mixture of hydrogen, which is an environmentally friendly raw material, and natural gas, along with steam, while significantly reducing greenhouse gases.

Hydrogen is efficient in the SAGD method because hydrogen has a higher heat capacity than steam, potentially delivering more heat to a reservoir and increasing the oil recovery rate.

Next, hydrogen may be used in in-situ combustion, which is a process in which hydrogen reacts with oil in the reservoir to generate heat and create conditions that promote oil flow. Furthermore, unlike a conventional combustion processes using natural gas, hydrogen combustion produces only water vapor as a byproduct, potentially reducing greenhouse gas emissions associated with the extraction process.

The present invention is applied to an e-methanol SAGD plant system used in unconventional oil production areas that recover bitumen from an oil sand deposit, basically a plant that supplies steam and hydrogen to the oil sand deposit to recover bitumen. In this process, instead of a conventional steam generator using natural gas, a hydrogen boiler, to which hydrogen in the commercialization phase is directly supplied so as to be used thereby, is used to generate steam in an environmentally friendly manner.

Furthermore, in areas where nearby natural gas production is feasible or where natural gas is readily accessible via pipelines, it is possible to replace a solvent used alongside steam and natural gas in the conventional SAGD method with hydrogen. To this end, a first water treatment module 101 is provided to remove impurities from feed water and produce purified water for steam generation and hydrogen production.

As previously described, source water obtained from natural environments such as ponds, reservoirs, or rivers, and tailing water present in the deposit after oil sand processing may be used as the feed water. The feed water is supplied as boiler fresh water (BFW) and water for water-electrolysis hydrogen production after impurities are removed therefrom through the first water treatment module 101.

At this time, water obtained from the tailing water may be supplied to a skim tank of a second water treatment module 108 and a hydrogen generation module 103, a description of which will follow, via a first distribution unit 118.

Furthermore, the boiler fresh water (BFW) may be supplied to a boiler module 102 and the hydrogen generation module 103 via a second distribution unit 119.

Subsequently, purified water, from which impurities have been removed by passing through the first water treatment module 101, is heated through the boiler module 102 to produce steam. Initially, steam is generated solely using purified water that has passed through the first water treatment module 101. However, as described later, water for steam generation may also be supplied to the boiler through a second water treatment module 113.

A part of the purified water, from which impurities have been removed by passing through the first water treatment module 101, is decomposed using electricity in the hydrogen generation module 103 to produce hydrogen. To this end, the hydrogen generation module 103 is provided with electricity, a catalyst, and a separator (membrane) to water-electrolyze the purified water, and a catalyst-free hydrogen generation technology using catalyst-free water electrolysis technology, which avoids the use of expensive catalysts such as platinum, iridium, or ruthenium, is employed to enhance competitiveness.

The electricity for water electrolysis may be sourced from renewable energy such as solar or wind power. This enables the production of green hydrogen, which is the most essential future energy for the carbon-neutral era and which is hydrogen produced with zero carbon emissions during a manufacturing process. Particularly, as renewable energy costs have recently declined, the benefits from green hydrogen may be significantly enhanced. Furthermore, the boiler module 102 is configured to use a part of the hydrogen produced by the hydrogen generation module 103 as fuel, thereby improving the overall system efficiency.

A part of the hydrogen produced by the hydrogen generation module 103 is supplied into the oil sand deposit and used as fuel for the boiler module 102, while the remainder is stored in an H₂ sales tank for various applications.

Steam produced by the boiler module 102 is supplied into the oil sand deposit via an injection well 105, and a part of the hydrogen produced by the hydrogen generation module 103 is also supplied into the oil sand deposit via a hydrogen supply unit 104. This enables the recovery of bitumen and gas from a producer well 106 installed at a lower part of the oil sand deposit, and separation of the gas component and bitumen from the producer well 106 is performed by a first separator 107.

At this time, the bitumen is in a state in which an oil component of the bitumen and water generated from the steam supplied to the oil sand deposit are mixed with each other, and the gas component is in a state in which the hydrogen supplied to the oil sand deposit and natural gas that either originally existed in the deposit or is separately mixed with hydrogen and supplied are mixed with each other. Since the gas component and the bitumen from the producer well 106 are in different states, the first separator 107 easily separates the gas component and the bitumen using the principle of separating gaseous and non-gaseous components from each other.

Furthermore, the bitumen recovered from the producer well 106 and separated by the first separator 107 is in a state in which the oil component and water are mixed with each other. Therefore, the bitumen that has passed through the first separator 107 undergoes separation of the water component via an oil-water separation module 108.

Specifically, the bitumen separated by the first separator 107 is transferred through a sludge pump and supplied to the oil-water separation module 108, and sand removal and dewatering may occur during this process. The oil-water separation module 108 employs a free water knockout (FWKO) system and is provided with a desalination module 109 to perform desalination on the water-separated bitumen.

Water separated through the oil-water separation module 108 is treated by a second water treatment module 113 using induced gas flotation (IGF) via the skim tank, and is then supplied to the boiler module 102 and the hydrogen generation module 103. At this time, water may be further supplied to the skim tank through a first distribution unit 118.

The IGF refers to a water treatment process that purifies wastewater (or other kinds of water) by removing floating substances such as oil or solids, and includes capacitive deionization (CDI), which removes ions using a ceramic membrane filter, a reverse osmosis (RO) filters, and electrical force and enables low-cost, high-efficiency purification for sewage treatment and chlorine desalination based on the super capacitor principle. Furthermore, sludge contained in a concentrate generated by the RO filter may be discharged and treated using zero liquid discharge (ZLD) technology, which re-circulates effluent without discharging the effluent.

In order to enhance the efficiency of the oil-water separation module 108, the system may include a diluent treatment module 114 provided with a diluent tank 115 configured to store diluent, a diluent supply unit 118 configured to supply the diluent to the oil-water separation module 108, and a diluent recovery unit 117 configured to recover the diluent from the bitumen that has passed through the oil-water separation module 108 and to supply the recovered diluents to the diluent tank 115.

The diluent in the diluent tank 115 is supplied to the back of a pre-head desander for sand removal and dehydration, and the diluent is recovered from the bitumen that has passed through the oil-water separation module 108 and supplied again through circulation, thereby enhancing the separation efficiency of water and the oil component.

The diluent may vary depending on the specific compositions of the bitumen. Depending on the various forms of hydrocarbon, C4 (butene), C5 (pentene), or C6 (hexene) may be used. The diluent is used during SAGD processing to aid in the effective separation and production of crude oil and water.

That is, in SAGD, crude oil is produced using a steam-assisted gravity drainage method. Consequently, the crude oil contains a significant amount of water along with the steam, necessitating the separation of the crude oil-water mixture. The diluent lowers the interfacial surface tension with water, promoting fluid separation. This facilitates more effective separation of water from the crude oil and aids in efficient oil recovery. Furthermore, high viscosity may impede fluid flow. The diluent reduces the viscosity of a non-Newtonian fluid with high viscosity, thereby improving the flow characteristics thereof.

In addition, the gas component that has passed through the first separator 107 may be utilized as fuel gas along with the gas component partially removed by the oil-water separation module 108. Moreover, since the gas component that has passed through the first separator 107 is a mixture primarily composed of natural gas and hydrogen, a second separator 110 configured to produce reformed hydrogen using the gas component that has passed through the first separator 107 may be provided to generate hydrogen. Furthermore, a part of the gas component that has passed through the first separator 107 may be used as fuel for the boiler module 102.

As previously described, when natural gas supply from an external source is stable, a first gas mixing module 111 may be provided. The first gas mixing module 111 may be connected to the hydrogen supply unit and may mix natural gas and hydrogen at a predetermined ratio before supplying the mixture into the oil sand deposit. Preferably, mixing natural gas and hydrogen at a ratio of 70:30 to 90:10 may significantly improve bitumen recovery efficiency.

Furthermore, the system may further include a second gas mixing module 112 configured to mix the natural gas separated by the second separator 110 with a part of the hydrogen produced by the hydrogen generation module at a predetermined ratio and to supply the mixture to the boiler module as fuel therefor, thereby reducing energy waste and increasing efficiency. In this case, it is desirable to mix natural gas and hydrogen at a ratio of 60:40 to 80:20.

According to the present invention, it is possible to reduce greenhouse gas emissions using green hydrogen in unconventional oil production areas, which are the worst offenders for greenhouse gas emissions, while simultaneously storing and supplying green hydrogen to realize P2G. Furthermore, it enables conversion into a new unconventional oil plant capable of simultaneously generating and utilizing both oil, essential to industry, and green hydrogen, indispensable for addressing global warming.

Blending hydrogen at 10 vol % into South Korea's annual natural gas consumption of 40 million tons may reduce natural gas usage by 1.29 million tons annually, achieving a reduction of 3.55 million tons of carbon dioxide per year. Furthermore, while environmental pollution regulations are tightening in Canada and other unconventional oil fields, leading to projections of significant future contraction in unconventional oil production, the present invention may offer an environmentally friendly solution to the challenges of unconventional oil production, and may greatly improve bitumen quality through hydrogenation reaction, which is one of the characteristics of hydrogen.

As previously described, since the present invention is applicable to areas where nearby natural gas production is feasible or where natural gas usage via pipelines is readily available, a gas supply unit 120 configured to receive natural gas from an external source is provided. The gas supply unit 120 supplies natural gas necessary to operate the plants, such as the first gas mixing module 111 and the second gas mixing module 112, including the boiler module 102.

In this case, as a type of flare system used for process safety in petrochemical, refining, and gas processing plants, a combustion unit 122 configured to safely process excess pressure or unnecessary gas by combusting the same in a flare stack instead of discharging the same into the atmosphere, thereby reducing emissions of harmful substances, is provided. That is, the equipment or the pipelines may be damaged if natural gas pressure abnormally increases during the process, and to relieve the pressure, the combustion unit 122 combusts the gas, thereby protecting the process and the environment. For this process, a knockout unit 121 configured to separate liquids, such as oil and condensate, from the gas flow, thereby maintaining stability, may be provided between the gas supply unit 120 and the combustion unit 122.

A gas capture unit 123 configured to capture CO₂ from a product generated by excess gas combustion is provided. The gas capture unit 123 employs flare CO₂ capture technology, which captures carbon dioxide (CO₂) from high-temperature exhaust gas released as a flare for environmental reuse or storage. Unlike general CO₂ capture processes, this specialized technology is designed to suit the flare's high temperatures, intermittent emissions, and high flow rates.

The exhaust gas from the combustion unit 122 consists of a high-temperature mixture of CO₂, nitrogen, methane, oxygen, etc. The exhaust gas is cooled to a state suitable for CO₂ capture, and during this process, particulate matter and other impurities are removed.

CO₂ capture employs methods such as selective absorption of CO₂ using an amine-based absorbent, such as monoethanolamine (MEA) or diethanolamine (DEA), adsorption of CO₂ using a material such as zeolite or activated carbon, and separation of CO₂ by membrane separation using a selective permeable membrane. The captured CO₂ may be concentrated to increase purity thereof and compressed for storage.

Subsequently, a methanol production unit 124 produces e-methanol using the hydrogen generated by the hydrogen generation module 103 and the CO₂ captured by the gas capture unit 123.

A process of producing methanol (CH₃OH) using the green hydrogen produced ecologically through the water electrolysis (PtG, Power-to-Gas) process and the carbon dioxide (CO₂) emitted from the process utilizes Fischer-Tropsch (FT) reaction technology using a chemical catalyst to convert gas into liquid fuel.

To this end, CO₂ and H₂ are first mixed with each other at an appropriate ratio (1:3 or 1:2) to create synthesis gas (syngas) suitable for a reaction condition, and this process proceeds according to the following reaction equations.

CO₂+3H₂→CH₃OH+H₂O, CO₂+H₂->CO+H₂O

In order to maximize the reaction efficiency of CO₂ and H₂, a combination of a transition metal catalyst and a specific catalyst, ruthenium (Ru), iron (Fe), nickel (Ni), or cobalt (Co), may be used. A catalyst specialized for methanol production is an oxide-based catalyst, such as Cu/Zn/Al₂O₃. This catalyst activates a step of converting CO₂ to CO and facilitates a combination of CO and H₂ to form a carbon-carbon bond (C—C bond).

In the present invention, the methanol production unit 124 is an FT reactor configured to promote the reaction at a pressure of 20 to 50 bar and a temperature of 200 to 300° C., and a fixed-bed reactor or a fluidized-bed reactor may be used. An FT reaction process includes a CO₂ activation step in which CO2 is reduced on the surface of the catalyst to form CO and a synthesis gas reaction step in which CO and H₂ are reacted with each other at the active site of the catalyst to form various hydrocarbons and oxygen compounds, thereby producing low-carbon alcohols including methanol through C—C bond formation.

Subsequently, methanol may be separated and purified from a reaction product through distillation and adsorption processes.

The e-methanol produced through the above processes may be used as automotive fuel, aviation fuel, and chemical feedstock. The e-methanol is a carbon-neutral fuel using carbon dioxide as fuel, and is used as an eco-friendly alternative to conventional fossil fuels.

As is apparent from the above description, the present invention has the effect that it is possible to efficiently recover bitumen from oil sands using only a mixture of natural gas and eco-friendly hydrogen produced by a water electrolysis apparatus and steam, instead of expanding solvent SAGD (ES-SAGD), which is a method using an additive (e.g., a solvent), and to significantly reduce greenhouse gases, which have been the most critical issue in this process, while producing e-methanol, which is eco-friendly fuel.

Unlike general methanol, the e-methanol produced according to the present invention is produced solely from green hydrogen and CO₂ captured through carbon capture, and is recognized as eco-friendly fuel, contributing to RE100. The e-methanol is gaining attention as an alternative energy source to petroleum, such as for marine propulsion fuel, and possesses significant scalability as the e-methanol can be transported through existing pipelines and general tank trucks.

Particularly, the CO₂ generation rate is significantly reduced through integration with green hydrogen production, thereby lowering carbon dioxide costs associated with carbon credits.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. An e-methanol SAGD plant system applicable to unconventional oil production areas that recover bitumen from an oil sand deposit, the e-methanol SAGD plant system comprising:
a first water treatment module configured to remove impurities from feed water in order to generate purified water;
a boiler module configured to heat the purified water in order to produce steam;
a hydrogen generation module configured to decompose the purified water using electricity in order to generate hydrogen;
an injection well configured to supply the steam into an oil sand deposit;
a hydrogen supply unit configured to supply a part of the hydrogen generated by the hydrogen generation module into the oil sand deposit;
a producer well configured to recover bitumen and gas from a lower part of the oil sand deposit;
a gas capture unit configured to receive natural gas from an external source and to capture CO₂ resulting from excess gas combustion; and
a methanol production unit configured to produce e-methanol using the hydrogen generated by the hydrogen generation module and the CO₂ captured by the gas capture unit.

2. The e-methanol SAGD plant system according to claim 1, wherein
the boiler module is configured to use the natural gas supplied from the external source and a part of the hydrogen generated by the hydrogen generation module as fuel, and
the e-methanol SAGD plant system further comprises a second separator configured to generate reformed hydrogen using a gas component that has passed through a first separator in which separation of a gas component and bitumen from the producer well is performed.

3. The e-methanol SAGD plant system according to claim 2, further comprising:
a first gas mixing module connected to the hydrogen supply unit, the first gas mixing module being configured to mix natural gas and hydrogen with each other at a set ratio and to supply the mixture into the oil sand deposit; and
a second gas mixing module configured to mix the natural gas separated by the second separator and a part of the hydrogen generated by the hydrogen generation module with each other at a set ratio and to supply the mixture to the boiler module as fuel therefor.

4. The e-methanol SAGD plant system according to claim 1, wherein the methanol production unit is constituted by a Fischer-Tropsch (FT) reactor configured to reduce CO₂ on a surface of a catalyst in order to form CO, to react CO and hydrogen with each other at an active site of the catalyst in order to form hydrocarbon and an oxygen compound, and to generate methanol through C—C bond formation.

5. The e-methanol SAGD plant system according to claim 4, wherein the methanol production unit separates and purifies methanol from a product generated by the FT reactor through distillation and adsorption processes.
